(19) United States
(12) Patent Application Publication
(10) Pub. No.: US 2024/0212039 A1
(43) Pub. Date: Jun. 27, 2024

(54) AUTOMATED NON-BILLING CYCLE REMITTANCE

(71) Applicant: American Express Travel Related Services Company, Inc., New York, NY (US)

(72) Inventors: Yatharth CHOWDHARY, Phoenix, AZ (US); Pankaj KOHLI, Phoenix, AZ (US); Surya B. PENTAPATI, Peoria, AZ (US); Andrew SOSNICKI, Phoenix, AZ (US); Ankush SRIVASTAVA, Phoenix, AZ (US)

(21) Appl. No.: 18/596,551

(22) Filed: Mar. 5, 2024

Related U.S. Application Data
(63) Continuation of application No. 17/496,497, filed on Oct. 7, 2021.
Application No. 17/496,497 is a continuation of application No. 16/247,740, filed on Jan. 15, 2019, now abandoned.

(51) Int. Cl. G06Q 40/02; G06F 9/48

(52) U.S. Cl. CPC G06Q 40/02; G06F 9/4843

(57) ABSTRACT

Disclosed are various embodiments for providing automated non-billing cycle remittances in order to load-balance batch processing jobs. An eligible user is identified for registration. Then, a registration request is sent to the user. Next, user registration data is received in response to the registration request, the user registration data specifying an event trigger. Then, it is determined that the processing event trigger has occurred. Subsequently, the processing event is executed in response to the processing event trigger occurring.

### CROSS-REFERENCE TO RELATED APPLICATIONS

This application is a continuation of, and claims priority to, co-pending U.S. application Ser. No. 17/496,497, filed Oct. 7, 2021, and entitled “LOAD-BALANCING BATCH PROCESSING JOBS THROUGH AUTOMATED NON-BILLING CYCLE REMITTANCE,” which is a continuation of U.S. application Ser. No. No. 16/247,740, filed Jan. 15, 2019, and entitled, “AUTOMATED NON-BILLING CYCLE REMITTANCE”, the entireties of which are incorporated herein by reference.

### FIELD

The disclosure generally relates to transaction account remittances, and more specifically, to systems and methods for automated transaction account remittances during non-billing cycles.

### BACKGROUND

Transaction accounts allow users to complete transactions using money provided by the transaction account issuer. The transaction account issuer may calculate the total amount of remittance owed by the user based on purchases made during a billing cycle, which typically ranges from 28 to 31 days. The transaction account issuer may calculate and generate a billing cycle statement and provide the user a fixed period to remit payment for the billing cycle statement. Typically, the transaction account issuer borrows money from a financial institution to pay for transactions completed during a given billing cycle, and then repays the financial institution after the transaction account users remit payment for the billing cycle. The money may be borrowed from the financial institution at varying interest rates. Thus, the longer the user waits to remit payment for the billing cycle, the more interest the financial institution will need to repay on the borrowed money.

Moreover, a technical problem is that the calculation and generation of billing cycle statements may be time and processing intensive. For example, batch jobs for calculating billing cycle balances may run daily and each individual job in the batch may take several hours to complete.

### SUMMARY

Systems, methods, and articles of manufacture (collectively, the “system”) for automated non-billing cycle remittances are disclosed. The system may retrieve user enrollment data comprising a remittance trigger. The system may determine a remittance event based on the remittance trigger. The system may process a non-billing cycle remittance based on the user enrollment data. The system may calculate a non-billing cycle reward based on the non-billing cycle remittance.

In various embodiments, in response to the remittance trigger comprising a remittance time period, the operation of determining the remittance event comprises comparing the remittance time period to a time period between a last user remittance date and a current date. In response to the remittance trigger comprising a remittance balance, the operation of determining the remittance event comprises comparing the remittance balance with a user account balance associated with the user enrollment data. The system may transmit a pending remittance event notification to a user associated with the user enrollment data. The system may distribute the non-billing cycle reward to a user account associated with the user enrollment data. The system may withdraw the non-billing cycle remittance from a transaction account associated with the user enrollment data. The operation of processing the non-billing cycle remittance may comprise applying the non-billing cycle remittance to repay the user account balance.

In various embodiments, the system may identify eligible user data from preprocessed user data. The system may communicate a non-billing cycle registration request to an eligible user from the eligible user data. The system may register the eligible user in response to receiving a user registration response, wherein the user registration response comprises a remittance trigger. The system may determine a remittance event based on the remittance trigger. The system may process a non-billing cycle remittance in response to determining the remittance event.

In various embodiments, the system may generate the eligible user data by filtering preprocessed user data based on a filtering input. The filtering input may comprise a remittance history, a remittance eligibility factor, and/or a remittance machine learning algorithm. The system may generate the preprocessed user data by preprocessing user data based on a risk processing input. The risk processing input may comprise an account status, a credit score, a debt to income ratio, and/or a risk processing model. The system may calculate a non-billing cycle reward based on the non-billing cycle remittance. The system may withdraw the non-billing cycle remittance from a transaction account associated with the eligible user, wherein the operation of processing the non-billing cycle remittance may comprise applying the non-billing cycle remittance to at least partially repay the user account balance.

The foregoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements.

FIG. 1 is a block diagram illustrating various system components of a system for automated non-billing cycle remittance, in accordance with various embodiments;

FIG. 2 is a block diagram illustrating various components of an exemplary enrollment targeting system for a system for automated non-billing cycle remittance, in accordance with various embodiments;

FIG. 3 illustrates a process flow for a method of user enrollment for automated non-billing cycle remittance, in accordance with various embodiments; and

FIG. 4 illustrates a process flow for a method of automated non-billing cycle remittance, in accordance with various embodiments.

### DETAILED DESCRIPTION

In various embodiments, systems for automated non-billing cycle remittances are disclosed. The system may enable users to register for non-billing cycle remittances based on a remittance time period (e.g., remit payment every two weeks) that is independent of a billing statement due date, account balance (e.g., remit payment at a defined account balance of $2000), or the like. The system may provide a reward (e.g., loyalty point payout, cashback, etc.) for users that complete non-billing cycle remittances. Therefore, the system may incentivize users to pay transaction account (e.g., credit card, charge card, accounts without a physical card, etc.) balances early and enable transaction account issuers to receive the user remittance, without needing to calculate and generate typical billing cycle statements. By receiving a user remittance earlier than in typical processes needing billing cycle statements, transaction account issuers may increase revenue by repaying borrowed money from financial institutions (e.g., early payments reduce the interest incurred on the borrowed money), by repurposing the earlier payments into new channels of lending, and/or the like.

The system therefore provides a technical solution to the technical problem caused by typical remittance processes requiring calculating and generating billing cycle statements. For example, typical remittance processes need multiple billing cycles starting at fixed daily times, with each cycle running for multiple hours and requiring overhead, processing, data storage, and system infrastructure needs. Moreover, typical cycles such as settlement cycles, balance cycles, monthly cycle cuts, remittance cycles, and the like may be interdependent, which may further add complexity to the calculation of requirement remittance amounts. In contrast, by automating remittance of transaction account balances within a typical billing cycle period, executing batch jobs for billing cycles (including interdependent cycles) may not be needed, thus decreasing utilization of CPU resources and system infrastructure, providing optimal load balancing for processing, and reducing data cluster and storage needs typically required for transaction account issuers.

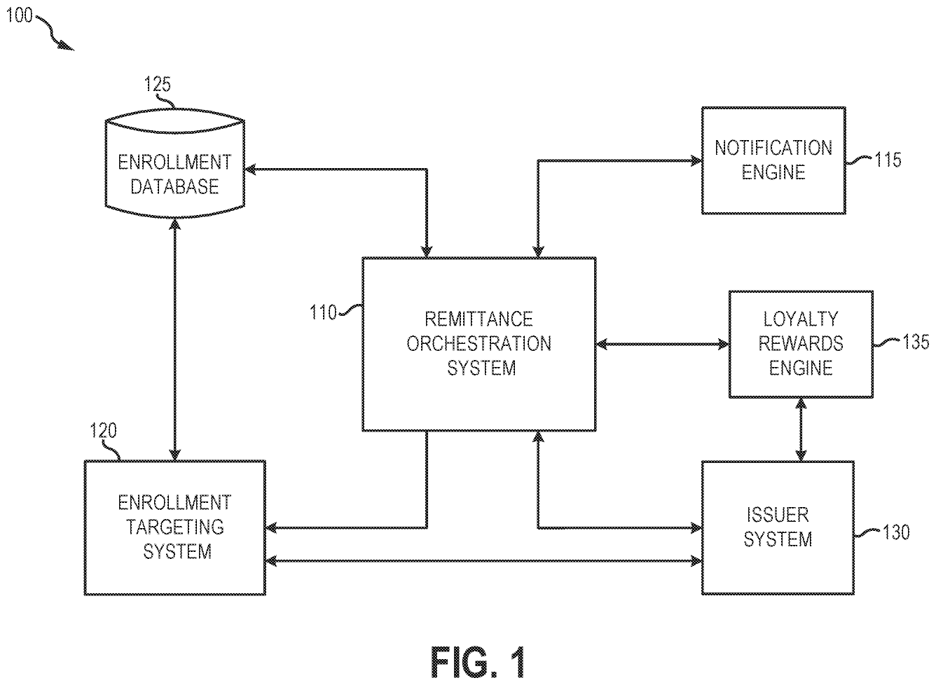

In various embodiments, and with reference to FIG. 1, a system 100 for automated remittance during non-billing cycles is disclosed. System 100 may comprise one or more remittance orchestration systems 110, notification engines 115, enrollment targeting systems 120, enrollment database 125, issuer systems 130, and/or loyalty rewards engines 135. System 100 may also contemplate uses in association with web services, utility computing, pervasive and individualized computing, security and identity solutions, autonomic computing, cloud computing, commodity computing, mobility and wireless solutions, open source, biometrics, grid computing, and/or mesh computing.

In various embodiments, remittance orchestration system 110 may be in electronic communication with notification engine 115, enrollment targeting system 120, enrollment database 125, issuer system 130, and/or loyalty rewards engine 135. Remittance orchestration system 110 may be configured to orchestrate communications amongst components in system 100 to enable non-billing cycle remittances, as discussed further herein. Remittance orchestration system 110 may comprise one or more hardware, software, and/or database components. For example, remittance orchestration system 110 may comprise one or more network environments, servers, computer-based systems, processors, databases, and/or the like. Remittance orchestration system 110 may comprise at least one computing device in the form of a computer or processor, or a set of computers/processors, although other types of computing units or systems may be used such as, for example, a server, web server, pooled servers, or the like. Remittance orchestration system 110 may also include software, such as services, APIs, and the like, configured to perform various operations discussed herein. In various embodiments, remittance orchestration system 110 may include one or more processors and/or one or more tangible, non-transitory memories and be capable of implementing logic. The processor may be configured to implement various logical operations in response to execution of instructions, for example, instructions stored on a non-transitory, tangible, computer-readable medium, as discussed further herein.

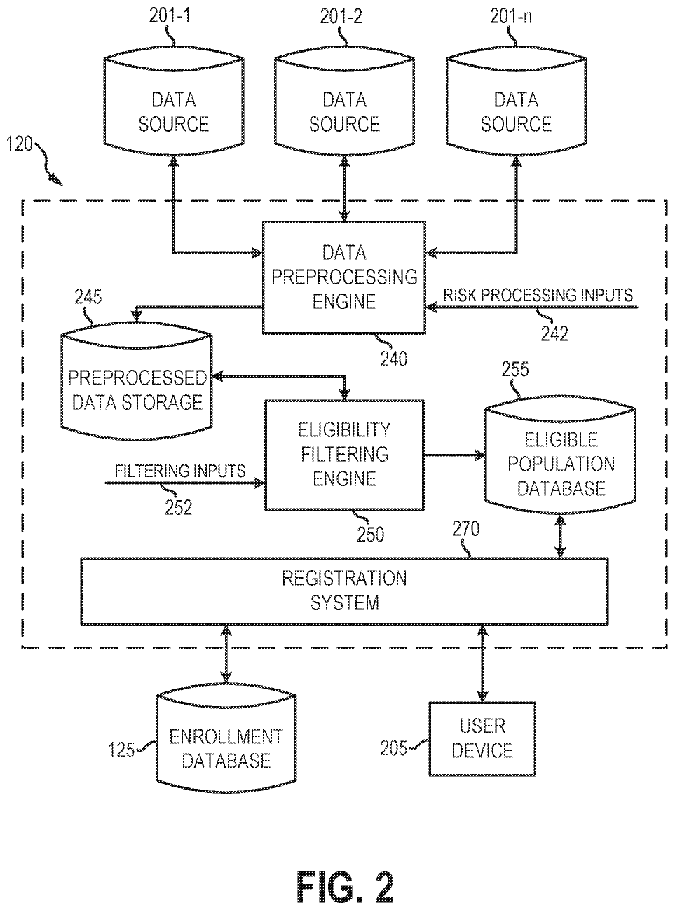

In various embodiments, remittance orchestration system 110 may comprise or be in electronic communication with notification engine 115. Notification engine 115 may be configured to transmit pending remittance notifications to a user (e.g., via user device 205, with brief reference to FIG. 2), as discussed further herein. Notification engine 115 may comprise one or more hardware or software components such as, for example, an API, web service, or the like. Notification engine 115 may transmit the pending remittance notifications using SMS, MMS, email, chat, push notification, or the like.

In various embodiments, issuer system 130 may be in electronic communication with remittance orchestration system 110, notification engine 115, enrollment targeting system 120, and/or loyalty rewards engine 135. Phrases and terms similar to “issuer system,” “transaction account issuer,” “financial institution,” or the like may include any entity that offers transaction account services. Although often referred to as a “financial institution,” issuer system 130 may represent any type of bank, lender, or other type of account issuing institution, such as transaction account companies, card sponsoring companies, or third-party issuers under contract with issuer system 130. Issuer system 130 may comprise a sub-network, computer-based system, software component, and/or the like configured to provide an access point to various systems, engines, servers, and components for a given transaction account issuer. Issuer system 130 may also be computer-based, and may and may comprise a processor, a tangible non-transitory computer-readable memory, and/or a network interface, along with other suitable system software and hardware components. Instructions stored on the tangible non-transitory memory may allow issuer system 130 to perform various functions, as described herein. In various embodiments, issuer system 130 may also comprise a transaction account issuer's Credit Authorization System (“CAS”) capable of authorizing transactions, as discussed further herein.

Issuer system 130 may include systems and databases related to financial and/or transactional systems and processes such as, for example, one or more authorization engines, authentication engines and databases, settlement engines and databases, accounts receivable systems and databases, accounts payable systems and databases, and/or the like. Issuer system 130 may also comprise and maintain one or more subscriber systems and databases comprising data corresponding to subscribed users such as, for example, user identifying data (e.g., first name, last name, username, address, etc.), transaction account data, account status, transaction history, payment history, and/or the like.

In various embodiments, loyalty rewards engine 135 may be in electronic communication with remittance orchestration system 110 and/or issuer system 130. In various embodiments, loyalty rewards engine 135 may comprise a sub-system, component, or network of issuer system 130. Loyalty rewards engine 135 may comprise any suitable combination of hardware, software, and/or database components. For example, loyalty rewards engine 135 may comprise one or more network environments, servers, computer-based systems, processors, databases, and/or the like. Loyalty rewards engine 135 may be configured to calculate a non-billing cycle reward based on non-billing cycle remittances, as discussed further herein. In various embodiments, loyalty rewards engine 135 may store and maintain data regarding accumulated user rewards. In various embodiments, loyalty rewards engine 135 may transmit the calculated non-billing cycle reward to issuer system 130, and issuer system 130 may store and maintain data regarding accumulated user rewards.

In various embodiments, loyalty rewards engine 135 may comprise any suitable system capable of offering a transaction-based reward (e.g., points, cryptocurrency, cashback, account credit, etc.) or similar rewards to transaction account users, such as those described in U.S. patent application Ser. No. 15/728,086, entitled “SYSTEMS AND METHODS FOR LOYALTY POINT DISTRIBUTION,” and filed on Oct. 9, 2017; U.S. patent application Ser. No. 15/956,982, entitled “REWARD POINT REDEMPTION FOR CRYPTOCURRENCY,” and filed on Apr. 19, 2018; and U.S. patent application Ser. No. 16/168,477, entitled “MULTI-MERCHANT LOYALTY POINT PARTNERSHIP,” and filed on Oct. 23, 2018; the contents of which are each incorporated by reference in their entirety.

In various embodiments, enrollment targeting system 120 may be in electronic communication with remittance orchestration system 110, issuer system 130, and/or enrollment database 125. Enrollment targeting system 120 may be configured to ingest and filter user data to determine users eligible for non-billing cycle remittances, and to enable eligible users to register for non-billing cycle remittances, as discussed further herein. In response to registering an eligible user for non-billing cycle remittances, enrollment targeting system 120 may store the user enrollment data in enrollment database 125, as discussed further herein. Enrollment database 125 may store the data using any suitable technique.

Enrollment targeting system 120 may comprise any suitable combination of hardware, software, and/or database components. For example, enrollment targeting system 120 may comprise one or more network environments, servers, computer-based systems, processors, databases, and/or the like. Enrollment targeting system 120 may comprise at least one computing device in the form of a computer or processor, or a set of computers/processors, although other types of computing units or systems may be used such as, for example, a server, web server, pooled servers, or the like. Enrollment targeting system 120 may also include one or more data centers, cloud storages, or the like, and may include software, such as APIs, services, or the like, configured to perform various operations discussed herein. In various embodiments, enrollment targeting system 120 may include one or more processors and/or one or more tangible, non-transitory memories and be capable of implementing logic. The processor may be configured to implement various logical operations in response to execution of instructions, for example, instructions stored on a non-transitory, tangible, computer-readable medium, as discussed further herein.

In various embodiments, enrollment targeting system 120 may comprise various software, hardware, and/or database components configured to aid enrollment targeting system 120 in ingesting and filtering user, determining eligible users, and registering uses for non-billing cycle remittances. For example, and with reference to FIG. 2, enrollment targeting system 120 may comprise one or more data preprocessing engines 240, preprocessed data storages 245, eligibility filtering engines 250, eligible population databases 255, and/or registrations systems 270.

In various embodiments, data preprocessing engine 240 may be in electronic communication with one or more data sources 201 and/or preprocessed data storage 245. Data preprocessing engine 240 may be configured to ingest user transaction account data from one or more data sources 201 such as, for example, a first data source 201-1, a second data source 201-2, and/or an “Nth” data source 201-n. Each data source 201 may comprise a source of user data such as, for example, user data provided by issuer system 130 (e.g., user identifying data, transaction account data, transaction history, remittance history, etc.), user credit scores or similar financial risk data (e.g., FICO®, TRANSUNION®, EQUIFAX®, CREDIT KARMA®, etc.), user financial information (e.g., debt to income ratio, etc.), and/or any other suitable user data. Data preprocessing engine 240 may comprise any suitable software, service, API, or the like configured to enable data preprocessing engine 240 to retrieve and/or receive data from one or more data sources 201. Data preprocessing engine 240 may be configured to ingest the user data as part of a batch job, in response to being instructed by a user or system, in response to new or updated user data being introduced into a data source 201, and/or the like.

Data preprocessing engine 240 may be configured to filter and/or preprocess the user data based on one or more risk processing inputs 242. In various embodiments, the risk processing inputs 242 may be configured to prefilter the user data based on a desired risk level. For example, the risk processing inputs 242 may be configured to filter user data to determine whether a user is suitable to enroll in non-billing cycle remittances, based on financial risk factors. The risk processing inputs 242 may comprise any suitable risk factors such as, for example, an account status, a credit score, a debt to income ratio, and/or the like. For example, in response to a first user account being inactive, the user having a low credit score (e.g., 500), and/or the user having a high debt to income ratio, data preprocessing engine 240 may filter the associated user data out as not being a candidate for non-billing cycle remittances. In various embodiments, the risk processing inputs 242 may also comprise a weighted risk processing model configured to intelligently filter the user data. The weighted risk processing model may weight each factor according to any desired configuration. In various embodiments, the risk processing inputs 242 may also comprise a Know Your Customer (KYC) assessment, an account in good standing status, a rolling account balance, a FICO score, a duplicate enrollment status, and/or any other suitable or desired financial or non-financial data. Data preprocessing engine 240 may be configured to transmit the preprocessed user data to preprocessed data storage 245. Preprocessed data storage 245 may store and maintain the preprocessed user data using any suitable technique.

In various embodiments, eligibility filtering engine 250 may be in electronic communication with preprocessed data storage 245 and/or eligible population database 255. Eligibility filtering engine 250 may be configured to retrieve the preprocessed user data from preprocessed data storage 245 and generate eligible user data based on filtering inputs 252. The filtering inputs 252 may be configured to identify users that may be good candidates for non-billing cycle remittances. For example, the filtering inputs 252 may comprise a remittance history (e.g., user remittances on time, late remittances, etc.), a remittance eligibility factor (e.g., an established account holder for 5 years, etc.), or a remittance machine learning algorithm. In various embodiments, each filtering input 252 may also be weighted according to any desired configuration. The remittance machine learning algorithm may comprise any suitable machine learning model or algorithm and may be trained to aid in identifying candidates for non-billing cycle remittances. For example, and in accordance with various embodiments, the remittance machine learning algorithm may be supervised and may be configured to classify output from the risk processing inputs 242 and the filtering inputs 252 with random forest models, gradient boosting models, or the like. In various embodiments, eligibility filtering engine 250 may also implement reinforcement learning techniques to enhance the remittance machine learning algorithm.

Eligibility filtering engine 250 may be configured to store the eligible user data in eligible population database 255. Eligible population database 255 may store and maintain the eligible user data using any suitable technique.

In various embodiments, registration system 270 may be in electronic communication with eligible population database 255, enrollment database 125, and/or one or more user devices 205. Registration system 270 may be configured to retrieve the eligible user data from eligible population database 255 and communicate with one or more users associated with the eligible user data, via one or more user devices 205. Each user device 205 may comprise a computer, tablet, smartphone, Internet of Things device (“IoT” device), and/or any other suitable hardware and/or software platform configured to enable internet-based communications. Registration system 270 may be configured to communicate with the eligible users, via user device 205, to notify the users that they are eligible for non-billing cycle remittances. Registration system 270 may communicate with the users using any suitable method. For example, registration system 270 may transmit a non-billing cycle registration request to user device 205 associated with the eligible user, via SMS, MMS, email, push notification, or the like. In various embodiments, registration system 270 may also communicate with the user, via user device 205, via an internet-based notification such as a web banner or targeted advertisement.

In response to a user desiring to register for non-billing cycle remittances, the user, via user device 205, may transmit a user registration request to registration system 270. The user registration request may comprise data indicating a request to register the eligible user for non-billing cycle remittances. The user registration request may comprise a specified transaction account for the non-billing cycle remittances to be automatically withdrawn from. The user registration request may also comprise a remittance trigger. The remittance trigger may specify when funds will be automatically withdrawn from the specified transaction account to complete non-billing cycle remittances. The remittance trigger may comprise a remittance time period, a remittance balance, or the like. For example, in response to the remittance time period being two weeks, the non-billing cycle remittance process may withdraw funds from the specified transaction account to complete the non-billing cycle remittance every two weeks (e.g., by comparing the remittance time period to a time period between a last user remittance date and a current date). As a further example, in response to the remittance balance being $2000, the non-billing cycle remittance process may withdraw funds from the specified transaction account to complete the non-billing cycle remittance in response to the user's account balance being at least $2000.

In response to receiving the user registration request, registration system 270 may complete user registration for non-billing cycle remittances. For example, registration system 270 may generate user enrollment data comprising the specified transaction account to withdraw remittances from, the remittance trigger, and/or any other suitable user data. Registration system 270 may be configured to communicate the registration information to issuer system 130. In response to receiving the registration information, issuer system 130 may be configured to associate the user enrollment data with the user account. Registration system 270 may be configured to store the user enrollment data in enrollment database 125. Registration system 270 may also be configured to notify user device 205 of successful registration such as, for example, via SMS, MMS, email, push notification, or the like.

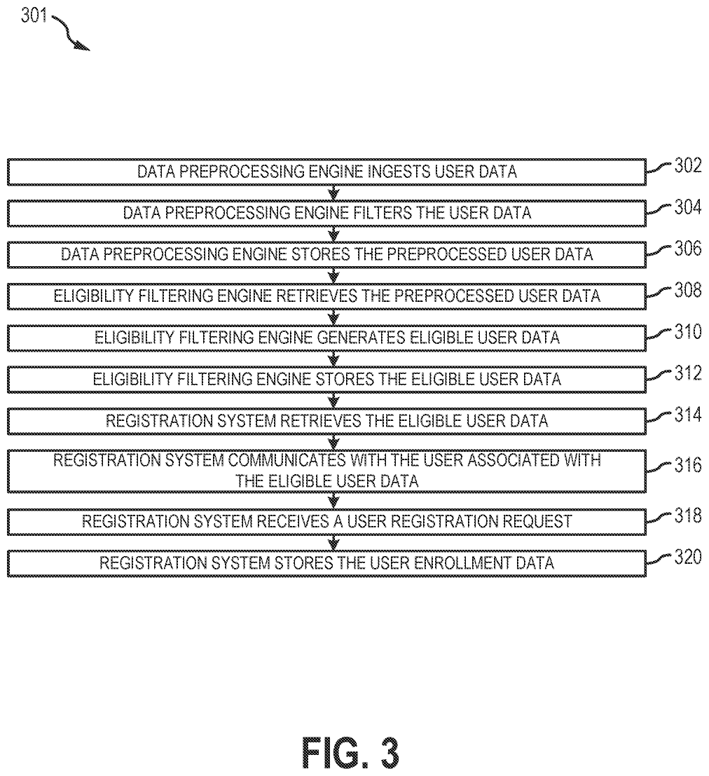

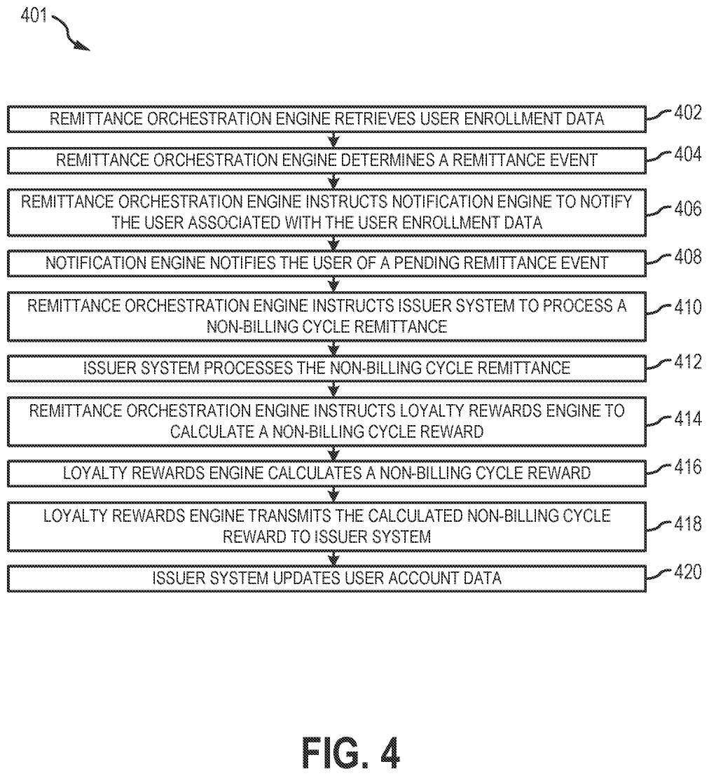

Referring now to FIGS. 3 and 4 the process flows depicted are merely embodiments and are not intended to limit the scope of the disclosure. For example, the steps recited in any of the method or process descriptions may be executed in any order and are not limited to the order presented. It will be appreciated that the following description makes appropriate references not only to the steps and user interface elements depicted in FIGS. 3 and 4, but also to the various system components as described above with reference to FIGS. 1 and 2. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below. Unless otherwise specifically noted, articles depicted in the drawings are not necessarily drawn to scale.

With specific reference to FIG. 3, a method 301 for user enrollment for automated non-billing cycle remittance is disclosed. Data preprocessing engine 240 ingests user data (step 302) from one or more data sources 201. Each data source 201 may comprise a source of user data such as, for example, user data provided by issuer system 130 (e.g., user identifying data, transaction account data, transaction history, remittance history, etc.), user credit scores or similar financial risk data (e.g., FICO®, TRANSUNION®, EQUIFAX®, CREDIT KARMA®, etc.), user financial information (e.g., debt to income ratio, etc.), and/or any other suitable user data. Data preprocessing engine 240 may be configured to ingest the user data as part of a batch job, in response to being instructed by a user or system, in response to new or updated user data being introduced into a data source 201, and/or the like.

In various embodiments, in response to ingesting the user data, data preprocessing engine 240 filters the user data (step 304) based on one or more risk processing inputs 242. In various embodiments, the risk processing inputs 242 may be configured to prefilter the user data based on a desired risk level. For example, the risk processing inputs 242 may be configured to filter user data to determine whether a user is suitable to enroll in non-billing cycle remittances, based on financial risk factors. The risk processing inputs 242 may comprise any suitable risk factors such as, for example, an account status, a credit score, a debt to income ratio, and/or the like. For example, in response to a first user account being inactive, the user having a low credit score (e.g., 500), and/or the user having a high debt to income ratio, data preprocessing engine 240 may filter the associated user data out as not being a candidate for non-billing cycle remittances. In various embodiments, the risk processing inputs 242 may also comprise a weighted risk processing model configured to intelligently filter the user data. The weighted risk processing model may weight each factor according to any desired configuration. In various embodiments, the risk processing inputs 242 may also comprise a Know Your Customer (KYC) assessment, an account in good standing status, a rolling account balance, a FICO score, a duplicate enrollment status, and/or any other suitable or desired financial or non-financial data.

In response to preprocessing and filtering the user data to generate preprocessed user data, data preprocessing engine 240 stores the preprocessed user data (step 306) in preprocessed data storage 245.

In various embodiments, eligibility filtering engine 250 retrieves the preprocessed user data (step 308) from preprocessed data storage 245. Eligibility filtering engine 250 may be configured to retrieve the preprocessed user data as part of a batch job, in response to being instructed by a user or system, in response to new or updated preprocessed user data being stored in preprocessed data storage 245, and/or the like. In response to retrieving the preprocessed user data, eligibility filtering engine 250 generates eligible user data (step 310) based on filtering inputs 252. The filtering inputs 252 may be configured to identify users that may be good candidates for non-billing cycle remittances. For example, the filtering inputs 252 may comprise a remittance history (e.g., user remittances on time, late remittances, etc.), a remittance eligibility factor (e.g., an established account holder for 5 years, etc.), or a remittance machine learning algorithm. As a further example, and in accordance with various embodiments, the filtering inputs 252 may comprise financial history data, financial standing data, spending pattern data, and/or any other suitable or desired financial or non-financial data. In various embodiments, each filtering input 252 may also be weighted according to any desired configuration. The remittance machine learning algorithm may comprise any suitable machine learning model or algorithm and may be trained to aid in identifying candidates for non-billing cycle remittances. Eligibility filtering engine 250 stores the eligible user data (step 312) in eligible population database 255.

In various embodiments, registration system 270 retrieves the eligible user data (step 314) from eligible population database 255. Registration system 270 may be configured to retrieve the eligible user data as part of a batch job, in response to being instructed by a user or system, in response to new or updated eligible user data being stored in eligible population database 255, and/or the like. In various embodiments, registration system 270 communicates with one or more users associated with the eligible user data (step 316). Registration system 270 may communicate with the users to notify the users that they are eligible for non-billing cycle remittances. Non-billing cycle may include any payment timeframe that is independent of a billing statement due date. Registration system 270 may communicate with the users using any suitable method. For example, registration system 270 may transmit a non-billing cycle registration request to user device 205 associated with the eligible user, via SMS, MMS, email, push notification, or the like. In various embodiments, registration system 270 may also communicate with the user, via user device 205, via an internet-based notification such as a web banner or targeted advertisement.

In various embodiments, registration system 270 receives a user registration request (step 318) from user device 205. The user registration request may comprise data indicating a request to register the eligible user for non-billing cycle remittances. The user registration request may comprise a specified transaction account for the non-billing cycle remittances to be automatically withdrawn from. The user registration request may also comprise a remittance trigger. The remittance trigger may specify when funds will be automatically withdrawn from the specified transaction account to complete non-billing cycle remittances. The remittance trigger may comprise a remittance time period, a remittance balance, or the like. For example, in response to the remittance time period being two weeks, the non-billing cycle remittance process may withdraw funds from the specified transaction account to complete the non-billing cycle remittance every two weeks (e.g., by comparing the remittance time period to a time period between a last user remittance date and a current date). As a further example, in response to the remittance balance being $2000, the non-billing cycle remittance process may withdraw funds from the specified transaction account to complete the non-billing cycle remittance in response to the user's account balance being at least $2000.

In response to receiving the user registration request, registration system 270 may complete user registration for non-billing cycle remittances. For example, registration system 270 may generate user enrollment data comprising the specified transaction account to withdraw remittances from, the remittance trigger, and/or any other suitable user data. Registration system 270 may communicate the registration with issuer system 130, and issuer system 130 may associate the user enrollment data with the user account. Registration system 270 stores user enrollment data in enrollment database 125 (step 320). Registration system 270 may notify user device 205 of successful registration such as, for example, via SMS, MMS, email, push notification, or the like.

With specific reference to FIG. 4, a method 401 for automated non-billing cycle remittance is disclosed. Remittance orchestration system 110 retrieves user enrollment data (step 402) from enrollment database 125. The user enrollment data may comprise the remittance trigger and/or any other suitable user data. Remittance orchestration system 110 determines a remittance event (step 404) based on the user enrollment data.

For example, and in accordance with various embodiments, wherein the remittance trigger comprises a remittance time period, remittance orchestration system 110 may determine the remittance event by comparing the remittance time period to a time period between a last user remittance date and a current date. For example, remittance orchestration system 110 may query issuer system 130 to provide user remittance data associated with the user enrollment data retrieved in step 402. The user remittance data may comprise data corresponding to remittances on the user account, such as, for example the last user remittance date. Based on the current date, remittance orchestration system 110 may calculate whether the remittance time period is equal to the elapsed time between the last user remittance date and the current date (e.g., a remittance time period of two weeks would be equal to a last user remittance date of December 1 and a current date of December 14). In response to the remittance time period being equal to the elapsed time between the last user remittance date and the current date, the remittance event is determined.

As a further example, and in accordance with various embodiments, wherein the remittance trigger comprises a remittance balance, remittance orchestration system 110 may determine the remittance event by comparing the remittance balance with a user account balance. For example, remittance orchestration system 110 may query issuer system 130 to provide the user account balance associated with the user enrollment data. Remittance orchestration system 110 may compare the remittance balance with the user account balance to determine the remittance event. For example, remittance orchestration system 110 may compare whether the user account balance is greater than or equal to the remittance balance (e.g., a user account balance of $2001 is greater than a remittance balance of $2000).

In various embodiments, in response to determining a remittance event, remittance orchestration system 110 instructs notification engine 115 to notify the user associated with the user enrollment data (step 406) of a pending remittance event. Notification engine 115 notifies the user of a pending remittance event (step 408). Notification engine 115 may transmit the remittance notification via SMS, MMS, email, push notification, automated voice messaging system, and/or the like. The remittance notification may comprise data notifying the user of the pending remittance event. For example, the remittance notification may notify the user that the automated non-billing cycle remittance will process in a processing time frame (e.g., 2 days) unless the user manually cancels the remittance.

In various embodiments, in response to the user canceling the pending remittance event, remittance orchestration system 110 may update the user enrollment data in enrollment database 125 to remove the remittance trigger associated with the user enrollment data. Remittance orchestration system 110 may also instruct issuer system 130 to revert to processing the user account in accordance with standard billing cycle statements. In various embodiments, remittance orchestration system 110 may also provide feedback of the cancellation to enrollment targeting system 120. In that respect, enrollment targeting system 120 may update filtering models and/or inputs (e.g., risk processing inputs 242, filtering inputs 252, etc.) to account for the canceled non-billing cycle remittance.

In various embodiments, in response to determining a remittance event, remittance orchestration system 110 instructs issuer system 130 to process a non-billing cycle remittance (step 410). Issuer system 130 processes the non-billing cycle remittance (step 412). Issuer system 130 may process the non-billing cycle remittance by withdrawing a remittance amount from the transaction account specified by the user. For example, in response to the remittance trigger being the remittance balance, issuer system 130 may withdraw the remittance amount equal to the remittance balance (e.g., $2000). As a further example, in response to the remittance trigger being the remittance time period, issuer system 130 may withdraw the remittance amount equal to the user's account balance. In response to successfully withdrawing the remittance amount, issuer system 130 may apply the remittance amount to the user's account balance to at least partially repay the outstanding balance.

In response to successfully processing the non-billing cycle remittance, issuer system 130 may return a success notification to remittance orchestration system 110. In response to receiving the success notification, remittance orchestration system 110 instructs loyalty rewards engine 135 to calculate a non-billing cycle reward (step 414). The non-billing cycle reward may comprise any suitable or desired reward such as, for example, loyalty points, cashback, an account credit, or the like. Loyalty rewards engine 135 calculates a non-billing cycle reward (step 416). Loyalty rewards engine may calculate the non-billing cycle reward based on the non-billing cycle remittance applied to the user's account balance (e.g., a loyalty point distribution of 5 points per a dollar). In response to calculating the non-billing cycle reward, loyalty rewards engine 135 transmits the calculated non-billing cycle reward (step 418) to issuer system 130. Issuer system 130 updates user account data (step 420) based on the calculated non-billing cycle reward. For example, issuer system 130 may distribute the non-billing cycle reward to the user account associated with the user.

The detailed description of various embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. Furthermore, any reference to singular includes plural embodiments, and any reference to more than one component may include a singular embodiment. Although specific advantages have been enumerated herein, various embodiments may include some, none, or all of the enumerated advantages.

Systems, methods, and computer program products are provided. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

As used herein, “transmit” may include sending at least a portion of electronic data from one system component to another. Additionally, as used herein, “data,” “information,” or the like may include encompassing information such as commands, queries, files, messages, data for storage, and the like in digital or any other form.

As used herein, “electronic communication” may comprise a physical coupling and/or non-physical coupling capable of enabling system components to transmit and receive data. For example, “electronic communication” may refer to a wired or wireless protocol such as a CAN bus protocol, an Ethernet physical layer protocol (e.g., those using 10BASE-T, 100BASE-T, 1000BASE-T, etc.), an IEEE 1394 interface (e.g., FireWire), Integrated Services for Digital Network (ISDN), a digital subscriber line (DSL), an 802.11a/b/g/n/ac signal (e.g., Wi-Fi), a wireless communications protocol using short wavelength UHF radio waves and defined at least in part by IEEE 802.15.1 (e.g., the BLUETOOTH® protocol maintained by Bluetooth Special Interest Group), a wireless communications protocol defined at least in part by IEEE 802.15.4 (e.g., the ZIGBEE® protocol maintained by the ZigBee alliance), a cellular protocol, an infrared protocol, an optical protocol, or any other protocol capable of transmitting information via a wired or wireless connection.

One or more of the system components may be in electronic communication via a network. As used herein, the term “network” may further include any cloud, cloud computing system, or electronic communications system or method that incorporates hardware and/or software components. Communication amongst the nodes may be accomplished through any suitable communication channels such as, for example, a telephone network, an extranet, an intranet, Internet, point of interaction device (personal digital assistant, cellular phone, kiosk, tablet, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using Internetwork Packet Exchange (IPX), APPLETALK® program, IP-6, NetBIOS, OSI, any tunneling protocol (e.g. IPsec, SSH, etc.), or any number of existing or future protocols. If the network is in the nature of a public network, such as the internet, it may be advantageous to presume the network to be insecure and open to eavesdroppers. Specific information related to the protocols, standards, and application software utilized in connection with the Internet is generally known to those skilled in the art and, as such, need not be detailed herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing.

The various system components may be independently, separately or collectively suitably coupled to the network via data links which includes, for example, a connection to an Internet Service Provider (ISP) over the local loop as is typically used in connection with standard modem communication, cable modem, DISH NETWORKS®, ISDN, DSL, or various wireless communication methods. It is noted that the network may be implemented as other types of networks, such as an interactive television (ITV) network. Moreover, the system contemplates the use, sale or distribution of any goods, services or information over any network having similar functionality described herein.

A network may be unsecure. Thus, communication over the network may utilize data encryption. Encryption may be performed by way of any of the techniques now available in the art or which may become available—e.g., Twofish, RSA, El Gamal, Schorr signature, DSA, PGP, PM, GPG (GnuPG), HPE Format-Preserving Encryption (FPE), Voltage, Triple DES, Blowfish, AES, MD5, HMAC, IDEA, RC6, and symmetric and asymmetric cryptosystems. Network communications may also incorporate SHA series cryptographic methods, elliptic-curve cryptography (e.g., ECC, ECDH, ECDSA, etc.), and/or other post-quantum cryptography algorithms under development.

For the sake of brevity, conventional data networking, application development, and other functional aspects of the system may not be described in detail herein. Furthermore, the connecting lines shown in the various figures contained herein are intended to represent exemplary functional relationships and/or electronic communications between the various elements. It should be noted that many alternative or additional functional relationships or electronic communications may be present in a practical system.

As used herein, “satisfy,” “meet,” “match,” “associated with”, or similar phrases may include an identical match, a partial match, meeting certain criteria, matching a subset of data, a correlation, satisfying certain criteria, a correspondence, an association, an algorithmic relationship, and/or the like. Similarly, as used herein, “authenticate” or similar terms may include an exact authentication, a partial authentication, authenticating a subset of data, a correspondence, satisfying certain criteria, an association, an algorithmic relationship, and/or the like.

Terms and phrases similar to “associate” and/or “associating” may include tagging, flagging, correlating, using a look-up table or any other method or system for indicating or creating a relationship between elements such as, for example, (i) a transaction account and (ii) an item (e.g., offer, reward, discount, etc.) and/or digital channel. Moreover, the associating may occur at any point, in response to any suitable action, event, or period of time. The associating may occur at pre-determined intervals, periodic, randomly, once, more than once, or in response to a suitable request or action. Any of the information may be distributed and/or accessed via a software enabled link, wherein the link may be sent via an email, text, post, social network input, and/or any other method known in the art.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS®, UNIX®, LINUX®, SOLARIS®, MACOS®, etc.) as well as various conventional support software and drivers typically associated with computers.

The present system, or any part(s) or function(s) thereof, may be implemented using hardware, software, or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations or any of the operations may be conducted or enhanced by artificial intelligence (AI) or machine learning. Artificial intelligence may refer generally to the study of agents (e.g., machines, computer-based systems, etc.) that perceive the world around them, form plans, and make decisions to achieve their goals. Foundations of AI include mathematics, logic, philosophy, probability, linguistics, neuroscience, and decision theory. Many fields fall under the umbrella of AI, such as computer vision, robotics, machine learning, and natural language processing. Useful machines for performing the various embodiments include general purpose digital computers or similar devices.

Any communication, transmission, communications channel, channel, and/or the like discussed herein may include any system or method for delivering content (e.g. data, information, metadata, etc.), and/or the content itself. The content may be presented in any form or medium, and in various embodiments, the content may be delivered electronically and/or capable of being presented electronically. For example, a channel may comprise a website, mobile application, or device (e.g., FACEBOOK®, YOUTUBE®, PANDORA®, APPLE TV®, MICROSOFT® XBOX®, ROKU®, AMAZON FIRE®, GOOGLE CHROMECAST™, SONY® PLAYSTATION®, NINTENDO® SWITCH®, etc.) a uniform resource locator (“URL”), a document (e.g., a MICROSOFT® Word™ or EXCEL®, an ADOBE® Portable Document Format (PDF) document, etc.), an “ebook,” an “emagazine,” an application or microapplication (as described herein), an SMS or other type of text message, an email, a FACEBOOK® message, a TWITTER® tweet, multimedia messaging services (MMS), and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network, and/or location based service. Distribution channels may include at least one of a merchant website, a social media site, affiliate or partner websites, an external vendor, and a mobile device communication. Examples of social media sites include FACEBOOK®, FOURSQUARE®, TWITTER®, LINKEDIN®, INSTAGRAM®, PINTEREST®, TUMBLR®, REDDIT®, SNAPCHAT®, WHATSAPP®, FLICKR®, VK®, QZONE®, WECHAT®, and the like. Examples of affiliate or partner websites include AMERICAN EXPRESS®, GROUPON®, LIVINGSOCIAL®, and the like. Moreover, examples of mobile device communications include texting, email, and mobile applications for smartphones.

Further, illustrations of the process flows and the descriptions thereof may make reference to user WINDOWS® applications, webpages, websites, web forms, prompts, etc. Practitioners will appreciate that the illustrated steps described herein may comprise in any number of configurations including the use of WINDOWS® applications, webpages, web forms, popup WINDOWS® applications, prompts, and the like. It should be further appreciated that the multiple steps as illustrated and described may be combined into single webpages and/or WINDOWS® applications but have been expanded for the sake of simplicity. In other cases, steps illustrated and described as single process steps may be separated into multiple webpages and/or WINDOWS' applications but have been combined for simplicity.

In various embodiments, components, modules, and/or engines of system 100, or one or more subcomponents of system 100, may be implemented as micro-applications or micro-apps. Micro-apps are typically deployed in the context of a mobile operating system, including for example, a WINDOWS® mobile operating system, an ANDROID® operating system, an APPLE® iOS operating system, a BLACKBERRY® operating system, and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

In various embodiments, the system may implement middleware to provide software applications and services, and/or to bridge software components in the computer-based system, such as the operating system, database, applications, and the like. Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the internet server. Middleware may be configured to process transactions between the various components of an application server and any number of internal or external systems for any of the purposes disclosed herein. WEBSPHERE® MQ™ (formerly MQSeries) by IBM®, Inc. (Armonk, N.Y.) is an example of a commercially available middleware product. An Enterprise Service Bus (“ESB”) application is another example of middleware.

The systems, computers, computer-based systems, and the like disclosed herein may provide a suitable website or other internet-based graphical user interface which is accessible by users. Practitioners will appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® applets, JAVASCRIPT® programs, active server pages (ASP), common gateway interface scripts (CGI), extensible markup language (XML), dynamic HTML, cascading style sheets (CSS), AJAX (Asynchronous JAVASCRIPT and XML) programs, helper applications, plug-ins, and the like. A server may include a web service that receives a request from a web server, the request including a URL and an IP address (192.168.1.1). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. As a further example, representational state transfer (REST), or RESTful, web services may provide one way of enabling interoperability between applications.

In various embodiments, one or more servers discussed herein may include application servers (e.g. WEBSPHERE®, WEBLOGIC®, JBOSS®, POSTGRES PLUS ADVANCED SERVER®, etc.). In various embodiments, the server may include web servers (e.g. Apache, IIS, GOOGLE® Web Server, SUN JAVA® System Web Server, JAVA® Virtual Machine running on LINUX® or WINDOWS® operating systems).

Users, systems, computer-based systems or the like may communicate with the server via a web client. The web client includes any device or software which communicates via any network such as, for example any device or software discussed herein. The web client may include internet browsing software installed within a computing unit or system to conduct online transactions and/or communications. These computing units or systems may take the form of a computer or set of computers, although other types of computing units or systems may be used, including personal computers, laptops, notebooks, tablets, smart phones, cellular phones, personal digital assistants, servers, pooled servers, mainframe computers, distributed computing clusters, kiosks, terminals, point of sale (POS) devices or terminals, televisions, or any other device capable of receiving data over a network. The web client may include an operating system (e.g., WINDOWS®, WINDOWS MOBILE® operating systems, UNIX′ operating system, LINUX® operating systems, APPLE® OS® operating systems, etc.) as well as various conventional support software and drivers typically associated with computers. The web-client may also run MICROSOFT® INTERNET EXPLORER® software, MOZILLA® FIREFOX® software, GOOGLE® CHROME® software, APPLE® SAFARI® software, or any other of the myriad software packages available for browsing the internet.

As those skilled in the art will appreciate, the web client may or may not be in direct contact with the server (e.g., application server, web server, etc., as discussed herein). For example, the web client may access the services of the server through another server and/or hardware component, which may have a direct or indirect connection to an internet server. For example, the web client may communicate with the server via a load balancer. In various embodiments, web client access is through a network or the internet through a commercially-available web-browser software package. In that regard, the web client may be in a home or business environment with access to the network or the internet. The web client may implement security protocols such as Secure Sockets Layer (SSL) and Transport Layer Security (TLS). A web client may implement several application layer protocols including HTTP, HTTPS, FTP, and SFTP.

Any databases discussed herein may include relational, hierarchical, graphical, blockchain, object-oriented structure, and/or any other database configurations. Any database may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2® by IBM® (Armonk, N.Y.), various database products available from ORACLE® Corporation (Redwood Shores, Calif.), MICROSOFT ACCESS® or MICROSOFT SQL SERVER® by MICROSOFT® Corporation (Redmond, Wash.), MYSQL® by MySQL AB (Uppsala, Sweden), MONGODB®, Redis, Apache Cassandra®, HBASE® by APACHE®, MapR-DB by the MAPR® corporation, or any other suitable database product. Moreover, any database may be organized in any suitable manner, for example, as data tables or lookup tables. Each record may be a single file, a series of files, a linked series of data fields, or any other data structure.

Any database discussed herein may comprise a distributed ledger maintained by a plurality of computing devices (e.g., nodes) over a peer-to-peer network. Each computing device maintains a copy and/or partial copy of the distributed ledger and communicates with one or more other computing devices in the network to validate and write data to the distributed ledger. The distributed ledger may use features and functionality of blockchain technology, including, for example, consensus-based validation, immutability, and cryptographically chained blocks of data. The blockchain may comprise a ledger of interconnected blocks containing data. The blockchain may provide enhanced security because each block may hold individual transactions and the results of any blockchain executables. Each block may link to the previous block and may include a timestamp. Blocks may be linked because each block may include the hash of the prior block in the blockchain. The linked blocks form a chain, with only one successor block allowed to link to one other predecessor block for a single chain. Forks may be possible where divergent chains are established from a previously uniform blockchain, though typically only one of the divergent chains will be maintained as the consensus chain. In various embodiments, the blockchain may implement smart contracts that enforce data workflows in a decentralized manner. The system may also include applications deployed on user devices such as, for example, computers, tablets, smartphones, Internet of Things devices (“IoT” devices), etc. The applications may communicate with the blockchain (e.g., directly or via a blockchain node) to transmit and retrieve data. In various embodiments, a governing organization or consortium may control access to data stored on the blockchain. Registration with the managing organization(s) may enable participation in the blockchain network.

Data transfers performed through the blockchain-based system may propagate to the connected peers within the blockchain network within a duration that may be determined by the block creation time of the specific blockchain technology implemented. For example, on an ETHEREUM®-based network, a new data entry may become available within about 13-20 seconds as of the writing. On a HYPERLEDGER® Fabric 1.0 based platform, the duration is driven by the specific consensus algorithm that is chosen and may be performed within seconds. In that respect, propagation times in the system may be improved compared to existing systems, and implementation costs and time to market may also be drastically reduced. The system also offers increased security at least partially due to the immutable nature of data that is stored in the blockchain, reducing the probability of tampering with various data inputs and outputs. Moreover, the system may also offer increased security of data by performing cryptographic processes on the data prior to storing the data on the blockchain. Therefore, by transmitting, storing, and accessing data using the system described herein, the security of the data is improved, which decreases the risk of the computer or network from being compromised.

In various embodiments, the system may also reduce database synchronization errors by providing a common data structure, thus at least partially improving the integrity of stored data. The system also offers increased reliability and fault tolerance over traditional databases (e.g., relational databases, distributed databases, etc.) as each node operates with a full copy of the stored data, thus at least partially reducing downtime due to localized network outages and hardware failures. The system may also increase the reliability of data transfers in a network environment having reliable and unreliable peers, as each node broadcasts messages to all connected peers, and, as each block comprises a link to a previous block, a node may quickly detect a missing block and propagate a request for the missing block to the other nodes in the blockchain network. For more information on distributed ledgers implementing features and functionalities of blockchain, see U.S. application Ser. No. 15/266,350 titled SYSTEMS AND METHODS FOR BLOCKCHAIN BASED PAYMENT NETWORKS and filed on Sep. 15, 2016, U.S. application Ser. No. 15/682,180 titled SYSTEMS AND METHODS FOR DATA FILE TRANSFER BALANCING AND CONTROL ON BLOCKCHAIN and filed Aug. 21, 2017, U.S. application Ser. No. 15/728,086 titled SYSTEMS AND METHODS FOR LOYALTY POINT DISTRIBUTION and filed Oct. 9, 2017, U.S. application Ser. No. 15/785,843 titled MESSAGING BALANCING AND CONTROL ON BLOCKCHAIN and filed on Oct. 17, 2017, U.S. application Ser. No. 15/785,870 titled API REQUEST AND RESPONSE BALANCING AND CONTROL ON BLOCKCHAIN and filed on Oct. 17, 2017, U.S. application Ser. No. 15/824,450 titled SINGLE SIGN-ON SOLUTION USING BLOCKCHAIN and filed on Nov. 28, 2017, U.S. application Ser. No. 15/824,513 titled TRANSACTION AUTHORIZATION PROCESS USING BLOCKCHAIN and filed on Nov. 28, 2017, U.S. application Ser. No. 15/943,168 titled TRANSACTION PROCESS USING BLOCKCHAIN TOKEN SMART CONTRACTS and filed on Apr. 2, 2018, U.S. application Ser. No. 15/943,271 titled FRAUD MANAGEMENT USING A DISTRIBUTED DATABASE and filed on Apr. 2, 2018, U.S. application Ser. No. 16/012,598 titled BUYER-CENTRIC MARKETPLACE USING BLOCKCHAIN and filed on Jun. 19, 2018, U.S. application Ser. No. 16/051,126 titled System and Method for Transaction Account Based Micro-Payments and filed on Jul. 31, 2018, and U.S. application Ser. No. 16/052,416 titled PROCUREMENT SYSTEM USING BLOCKCHAIN and filed on Aug. 1, 2018, the contents of which are each incorporated by reference in its entirety.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); data stored as Binary Large Object (BLOB); data stored as ungrouped data elements encoded using ISO/IEC 7816-6 data elements; data stored as ungrouped data elements encoded using ISO/IEC Abstract Syntax Notation (ASN.1) as in ISO/IEC 8824 and 8825; other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored in association with the system or external to but affiliated with system. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data, in the database or associated with the system, by multiple and unrelated owners of the data sets. For example, a first data set which may be stored may be provided by a first party, a second data set which may be stored may be provided by an unrelated second party, and yet a third data set which may be stored, may be provided by a third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, the data set (e.g., BLOB) may be annotated in a standard manner when provided for manipulating the data in the database or system. The annotation may comprise a short header, trailer, or other appropriate indicator related to each data set that is configured to convey information useful in managing the various data sets. For example, the annotation may be called a “condition header,” “header,” “trailer,” or “status,” herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user, or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer, may be received by a standalone interaction device configured to add, delete, modify, or augment the data in accordance with the header or trailer. As such, in one embodiment, the header or trailer is not stored on the transaction device along with the associated issuer-owned data but instead the appropriate action may be taken by providing to the user at the standalone device, the appropriate option for the action to be taken. The system may contemplate a data storage arrangement wherein the header or trailer, or header or trailer history, of the data is stored on the system, device or transaction instrument in relation to the appropriate data.

One skilled in the art will also appreciate that, for security reasons, any databases, systems, devices, servers, or other components of the system may consist of any combination thereof at a single location or at multiple locations, wherein each database, system, device, server, and/or other component includes any of various suitable security features, such as firewalls, access codes, encryption, decryption, compression, decompression, and/or the like.

Encryption of data in system 100, including in one or more databases, may be performed by way of any of the techniques now available in the art or which may become available—e.g., Twofish, RSA, El Gamal, Schorr signature, DSA, PGP, PM, GPG (GnuPG), HPE Format-Preserving Encryption (FPE), Voltage, Triple DES, Blowfish, AES, MD5, HMAC, IDEA, RC6, and symmetric and asymmetric cryptosystems. The systems and methods may also incorporate SHA series cryptographic methods, elliptic-curve cryptography (e.g., ECC, ECDH, ECDSA, etc.), and/or other post-quantum cryptography algorithms under development.

A firewall may include any hardware and/or software suitably configured to protect CMS components and/or enterprise computing resources from users of other networks. Further, the firewall may be configured to limit or restrict access to various systems and components behind the firewall for web clients connecting through a web server. The firewall may reside in varying configurations including Stateful Inspection, Proxy based, access control lists, and Packet Filtering among others. The firewall may be integrated within a web server or any other CMS components or may further reside as a separate entity. The firewall may implement network address translation (“NAT”) and/or network address port translation (“NAPE”). The firewall may accommodate various tunneling protocols to facilitate secure communications, such as those used in virtual private networking. The firewall may implement a demilitarized zone (“DMZ”) to facilitate communications with a public network such as the internet. The firewall may be integrated as software within an internet server, any other application server components or may reside within another computing device or may take the form of a standalone hardware component.

The system and method may be described herein in terms of functional block components, screen shots, optional selections, and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT®, JAVASCRIPT® Object Notation (JSON), VBScript, Macromedia COLD FUSION, COBOL, MICROSOFT® company's Active Server Pages, assembly, PERL®, PHP, awk, PYTHON®, Visual Basic, SQL Stored Procedures, PL/SQL, any UNIX® shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT®, VBScript, or the like. Cryptography and network security methods are well known in the art, and are covered in many standard texts.

In various embodiments, the software elements of the system may also be implemented using NODE.JS® components. NODE.JS® programs may implement several modules to handle various core functionalities. For example, a package management module, such as NPM®, may be implemented as an open source library to aid in organizing the installation and management of third-party NODE.JS® programs. NODE.JS® programs may also implement a process manager such as, for example, Parallel Multithreaded Machine (“PM2”); a resource and performance monitoring tool such as, for example, Node Application Metrics (“appmetrics”); a library module for building user interfaces, and/or any other suitable and/or desired module.

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet-based embodiment, an entirely hardware embodiment, or an embodiment combining aspects of the internet, software, and hardware. Furthermore, the system may take the form of a computer program product on a computer-readable storage medium having computer-readable program code means embodied in the storage medium. Any suitable computer-readable storage medium may be utilized, including hard disks, CD-ROM, SONY BLU-RAY DISC®, optical storage devices, magnetic storage devices, and/or the like.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In re Nuijten to fall outside the scope of patentable subject matter under 35 U.S.C. § 101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Although the disclosure includes a method, it is contemplated that it may be embodied as computer program instructions on a tangible computer-readable carrier, such as a magnetic or optical memory or a magnetic or optical disk. All structural, mechanical, electrical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. § 112(f) unless the element is expressly recited using the phrase “means for” or “step for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Therefore, the following is claimed:

1. A system, comprising:
a computing device comprising a processor and a memory; and
machine-readable instructions stored in the memory that, when executed by the processor, cause the computing device to at least:
ingest user account data, the user account data comprising user financial information;
use a remittance machine learning algorithm to determine user eligibility for a subscription to a non-billing cycle remittance system, the remittance machine learning algorithm being configured to classify outputs from at least one or more filtering inputs from the user account data;
notify an eligible user of the subscription to the non-billing cycle remittance system;
receive, from a device associated with the eligible user, a registration request regarding the subscription to the non-billing cycle remittance system, the registration request comprising a transaction account and a remittance trigger; and
store details associated with a subscription of the eligible user to the non-billing cycle remittance system.

2. The system of claim 1, wherein the machine-readable instructions, when executed by the processor, further cause the computing device to at least register the eligible user for the subscription to the non-billing cycle remittance system in response to receiving the registration request.

3. The system of claim 1, wherein the remittance trigger comprises a comparison of a user defined remittance time period to a length of time between a last user remittance and a current date.

4. The system of claim 1, wherein the at least one or more filtering inputs comprise a remittance history or a remittance eligibility factor.

5. The system of claim 1, wherein the machine-readable instructions, when executed by the processor, further cause the computing device to at least remove the user from the subscription to the non-billing cycle remittance system in response to a notification of a canceled non-billing cycle remittance.

6. The system of claim 5, wherein the machine-readable instructions, when executed by the processor, further cause the computing device to at least update the at least one or more filtering inputs to account for the canceled non-billing cycle remittance.

7. The system of claim 5, wherein the machine-readable instructions, when executed by the processor, further cause the computing device to at least update the stored details to account for the canceled non-billing cycle remittance.

8. The system of claim 1, wherein the machine-readable instructions, when executed by the processor, further cause the computing device to apply a reward to user account data of the eligible user, the reward comprising loyalty points, cashback, or an account credit.

9. A method, comprising:
ingesting user account data associated with a plurality of users, the user account data comprising user financial information associated with each of the plurality of users;
using a remittance machine learning algorithm on the user account data to determine which users of the plurality of users are eligible for a subscription to a non-billing cycle remittance system, the remittance machine learning algorithm being configured to classify each output from at least one or more filtering inputs from the user account data;
notifying one or more eligible users of the subscription to the non-billing cycle remittance system;
receiving, from a device associated with an eligible user of the one or more eligible users, a registration request regarding the subscription to the non-billing cycle remittance system, the registration request comprising a transaction account and a remittance trigger; and
storing details associated a subscription of the eligible user to the non-billing cycle remittance system.

10. The method of claim 9, further comprising at least registering the eligible user for the subscription to the non-billing cycle remittance system in response to receiving the registration request.

11. The method of claim 9, further comprising notifying the eligible user of a registration to the non-billing cycle remittance system, the notifying occurring at least in part via SMS, MMS, email, or push notification.

12. The method of claim 9, wherein stored details further comprise at least user identifying data, user transaction account data, a user account status, user transaction history, or user payment history.

13. The method of claim 9, further comprising updating stored details in response to the eligible user canceling a pending remittance.

14. The method of claim 9, wherein the remittance trigger further comprises a comparison of a user defined remittance balance to a balance of a user account.

15. The method of claim 9, further comprising applying, based on the non-billing cycle remittance, a reward to an account associated with the eligible user.

16. The method of claim 9, further comprising prefiltering user account data based at least in part on one or more risk processing inputs.

17. A non-transitory, computer-readable medium comprising machine-readable instructions that, when executed by a processor of a computing device, cause the computing device to at least:
ingest user account data, the user account data comprising user financial information;
prefilter user account data based at least in part on one or more risk processing inputs;
use a remittance machine learning algorithm to determine user eligibility for a subscription to a non-billing cycle remittance system, the remittance machine learning algorithm being configured to classify each output from the one or more risk processing inputs and at least one or more filtering inputs from the user account data;
notify an eligible user of the subscription to the non-billing cycle remittance system;
receive, from a device associated with the eligible user, a registration request regarding the subscription to the non-billing cycle remittance system, the registration request comprising a transaction account and a remittance trigger; and
store details associated with a subscription of the eligible user to the non-billing cycle remittance system.

18. The non-transitory, computer-readable medium of claim 17, wherein the remittance trigger further comprises a comparison of:
a user defined remittance time period to a length of time between a last user remittance and a current date; or
a user defined remittance balance to a balance of a user account.

19. The non-transitory, computer-readable medium of claim 17, further comprising associating a user account with a loyalty reward in response to a remittance, the loyalty reward comprising loyalty points, cashback, or an account credit.

20. The non-transitory, computer-readable medium of claim 17, wherein the risk processing inputs comprise an account status, at least one credit score, or a debt-to-income ratio.
